(19) United States
(12) Patent Application Publication
(10) Pub. No.: US 2006/0273604 A1
(43) Pub. Date: Dec. 7, 2006

(54) Mobile serving unit

(76) Inventor: Marcel Luthe, Berlin (DE)

Correspondence Address: HOUSTON ELISEEVA, 4 MILITIA DRIVE, SUITE 4, LEXINGTON, MA, 02421, US

(21) Appl. No.: 11/184,744

(22) Filed: Jul. 19, 2005

(30) Foreign Application Priority Data
Jun. 3, 2005 (DE) DE 202005008720.3

(51) Int. Cl. B60P 3/025

(52) U.S. Cl. 296/22

(57) ABSTRACT

A mobile serving unit has one or more serving platforms, and a pedal-operated transport unit for moving the serving platform, also an appliance which may be operated at least partly by gas, for the preparation of food and/or drink.

### RELATED APPLICATIONS

This application claims priority to Germany Application No. DE 20 2005 008 720.3, filed on Jun. 3, 2005, which is incorporated herein by reference in its entirety.

### BACKGROUND OF THE INVENTION

Already known is the serving of food and drink from motor vehicles, e.g. pickup trucks, which have a sales platform on the load area. The power needed for the preparation and heating of food and drink, e.g. coffee, is supplied by units with petrol or diesel internal combustion engines, which may be fed without difficulty through the motor vehicle or from stationary connections. This brings the disadvantage that such vehicles may not be operated everywhere, e.g. often not in recreational areas such as parks and green spaces or on footpaths, firstly because of the noise and stink of the internal combustion engines, and secondly because the motor vehicles are relatively large. Setting up and putting away is also relatively time-consuming so that, while the vehicles can move from one site to another, they can react only with difficulty to customer requests while they are “on the move.” They are therefore virtually static in terms of the selling process.

A further known and more flexible mobile serving unit involves a bicycle-like framework, e.g. pedal-operated or in the form of a moped, which also carries with it a sales platform. Since an internal combustion engine for the preparation of food and drink would be too heavy and too loud, such serving units provide only prepared fare, e.g. previously brewed coffee from THERMOS or insulated flasks, or ice cream from pre-cooled, insulated containers. Such serving units are often also able to travel where the motor vehicles referred to above cannot go or are forbidden from going, e.g. on to green spaces. Moreover, an operator of the serving unit (hereafter referred to as the seller) can also bring it into operation relatively easily in such areas, allowing a quick reaction to customer requests. A disadvantage, though, is that the food and drink are no longer fresh. For example, while coffee remains hot in insulated flasks, it becomes stale as its caffeine content reduces. The seller therefore has to return frequently to a refilling point to obtain fresh coffee. As a result, the seller has a limited selling radius, must reckon with dead periods as regards sales when traveling to and fro, and—depending on customer interest—has to throw away unsold coffee.

### SUMMARY OF THE INVENTION

The invention relates to a mobile serving unit, in particular for the serving of coffee, and also a method for operation of the serving unit.

The present invention is directed to a serving unit that can firstly go where vehicles with internal combustion engines are unable to go or are banned from going, e.g. in parks and on footpaths, secondly can easy to bring into operation, and thirdly can still allow for the fresh preparation of food and drink that needs to be heated for consumption, in particular coffee.

The invention further provides a method of operating the serving unit, in particular for the sale of hot drinks, in particular coffee.

The problem is solved by providing a mobile serving unit comprising one or more serving platforms, together with a pedal-operated transport unit for moving the serving platform. Also provided is at least one appliance for the heating of food and drink, in particular coffee, which may be operated at least partly by gas.

Through the use of gas, significant drawbacks of internal combustion engines, namely noise and stink, may be avoided, thereby allowing for use even in recreational areas such as parks, etc. or on or adjacent to footpaths. Moreover, in comparison with internal combustion engines, gas containers are relatively small and lightweight. On the other hand the (fuel) gas provides an energy source which allows long use and plenty of energy. This avoids the need for frequent return to a refilling point.

In principle the appliance which may be operated at least partly by gas may also be an electrical appliance which obtains its current through a gas-electricity conversion, i.e. gas is burned and converted into electrical current which is used to operate the electrical appliance. This has the advantage that conventional electrical appliances may be used, but the disadvantage that an expensive and somewhat wasteful gas-electric converter must be used.

The preferred course of action is therefore to use appliances which, for at least part of their functions, are operated directly with gas. This may be for example a coffee making machine in which the water is heated by gas, e.g. for the fresh brewing of coffee, for example on a strainer holder, or to provide steam, e.g. for the foaming of milk or the preparation of tea. An electrical and/or electronic control unit and/or a grinder and/or a water pump may be operated through an additional power source, such as for example a battery. An example of an appliance which may be operated entirely by gas is a toaster for hot toasts, pannini and the like.

The problem of the invention is also solved by a method for the operation of a mobile serving unit.

In a first operating process (a first selling process), sales are made “on the move,” i.e. the business transaction is initiated when the seller is still moving the mobile serving unit, e.g. is cycling around with the latter in a park. A purchaser gives the seller one or more purchase signals, e.g. a hand movement, whereupon the seller stops the mobile serving unit. Optionally, the seller then (quickly) sets up the mobile serving unit, e.g. by extending supports or by jacking it up. The seller then prepares one or more hot drinks in the mobile serving unit and serves it or them to the customer. With previous or subsequent payment for the hot drink, the sales process is complete. The seller may then continue his journey or advantageously sell more hot drinks, e.g. to further purchasers.

In another operating process (second selling method), the seller moves the mobile serving unit to a location which has no supply connection usable by the seller, and there sets up the serving unit for a certain period of time, e.g. half an hour. In this period he sells or tries to sell hot drinks freshly prepared in the mobile serving unit, and then sets up the serving unit temporarily in another location. These sales points may be located where motor vehicles are not allowed, e.g. in parks, etc.

Further advantageous variants may be inferred from the dependent claims, separately or in combination.

The invention is explained in detail below, with the aid of schematic embodiments used as examples. It should be clear that the embodiments do not restrict the scope of the invention, which is defined by the claims.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a mobile serving unit in a sectional side view;

FIG. 2 shows the mobile serving unit of FIG. 1 in a sectional front view;

FIG. 3 shows a serving platform of the mobile serving unit of FIGS. 1 and 2 viewed from an angle;

FIG. 4 shows a flow chart of a first operating process for a mobile serving unit;

FIG. 5 shows a flow chart of a further operating process for a mobile serving unit.

### DETAILED DESCRIPTION OF THE PREFERRED EMBODIMENTS

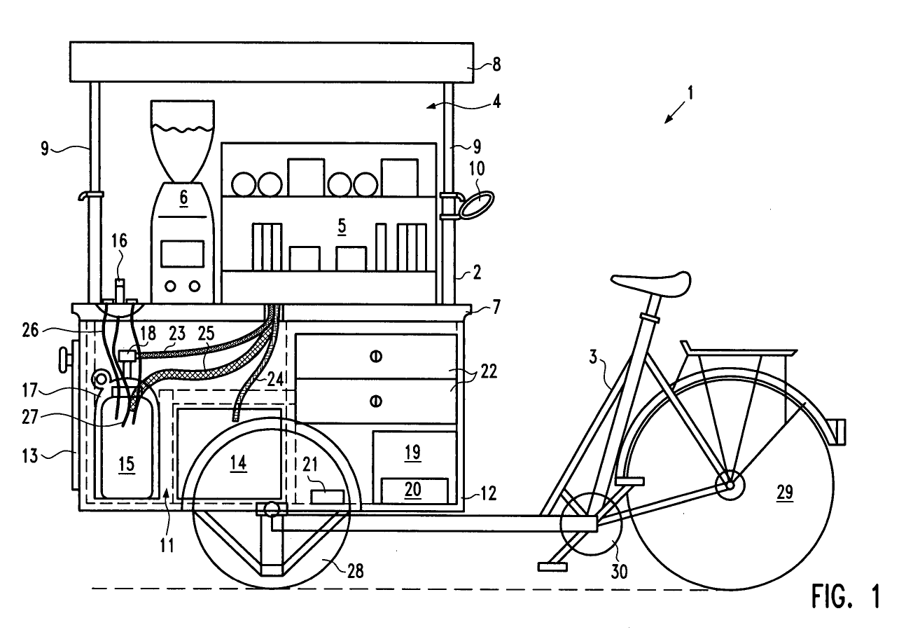

FIG. 1 shows an embodiment of a mobile serving unit 1 viewed from the side with a section through a serving platform 2.

The mobile serving unit 1 has a serving platform 2 fixed to a transport unit 3 which may be pedal-driven. The serving platform 2 has two levels, with an at least partly gas-powered coffee making machine 5 and a coffee grinder 6 accommodated on an upper level 4.

Types of gas include hydrocarbon based fuels such as gasoline, kerosene, alcohol, natural gas, propane, butane, naphtha, methane, fuel oil including diesel fuel, and Liquefied petroleum gas, to list a few examples.

The upper level 4 is open at least on the side from which the coffee making machine 5 is operated. It is formed by an intermediate surface 7 which is 45 mm thick, over which a roof 8 of 300 mm in height is supported by bars 9. The usable height of the upper level 4 without roof 8 is 625 mm. A rear-view mirror 10 is fitted to one of the bars 9.

A lower level 11 including a base plate 12 has a height of 575 mm and is covered in normal operation. Flaps 13 of 455 mm in height are provided on the front for access to the inside. The overall length of the serving platform 2 is 1245 mm, and that of the lower level 11 including walls is 1198 mm.

Accommodated on the lower level 11 are: a first fresh water tank 14 to supply a strainer holder (not shown) of the coffee making machine 5 with fresh water, a second fresh water tank 15 to supply a water tap 16, which can be shut off, with fresh water, a waste water container (not shown), a gas storage container in the form of a gas cylinder 17 with a valve 18, an electrical power storage unit in the form of a battery 19 for 12 V/130 A, an inverter 20 for converting the DC voltage of the battery 19 into AC voltage which may be used for the coffee making machine 5 and the grinder 6, a battery charger 21 to charge the battery 19, and drawers 22.

Through the intermediate surface 7, a gas pipe 23 is fed from the gas cylinder 17, and a first fresh water pipe 24 from the first fresh water tank 14, to the coffee making machine 5. From the coffee making machine 5, a first waste water pipe 25 leads to the waste water tank (not shown). Let into the intermediate surface 7 and operable from the upper level 4 is the water tap 16, which obtains fresh water from the second fresh water tank 15 via a second fresh water pipe 26; this is discharged via a second waste water pipe 27 to the waste water tank. For better clarity, any pumps provided are not shown here.

The transport unit 3 which may be pedal-operated is a cycle with two front wheels 28 and a rear wheel 29, with the latter capable of being driven by the pedals 30.

The serving platform 2 is fixed to the transport unit 3 so as to follow the steering movement of the front wheels 28.

Naturally it is possible to vary the dimensions (height, width, etc.) of the individual components such as the serving platform 2 or the transport unit 3.

The mobile serving platform 2 may also be constructed in one piece or with more than two platforms or levels.

The coffee making machine 5 is able to make ordinary coffee, also espresso and its variations (latte macchiato, cappuccino, etc.), e.g. using a directly gas-powered boiler. The coffee making machine 5 may also have an integral grinder.

Alternatively or additionally, however, it is also possible to make other fresh food and drink, e.g. tea, cocoa, etc., also solid meals such as toasts, pannini, etc. which may be heated for example by a gas-powered grill.

Various other appliances may be operated through the energy storage unit 19, such as a water pump for the water tap 16 or for the coffee making machine 5, etc.

The transport unit 3 may be equipped with an auxiliary motor, if necessary removable, e.g. an electric motor or a small internal combustion engine, to facilitate movement in ordinary road traffic. This is typically switched off on footpaths or in recreational areas.

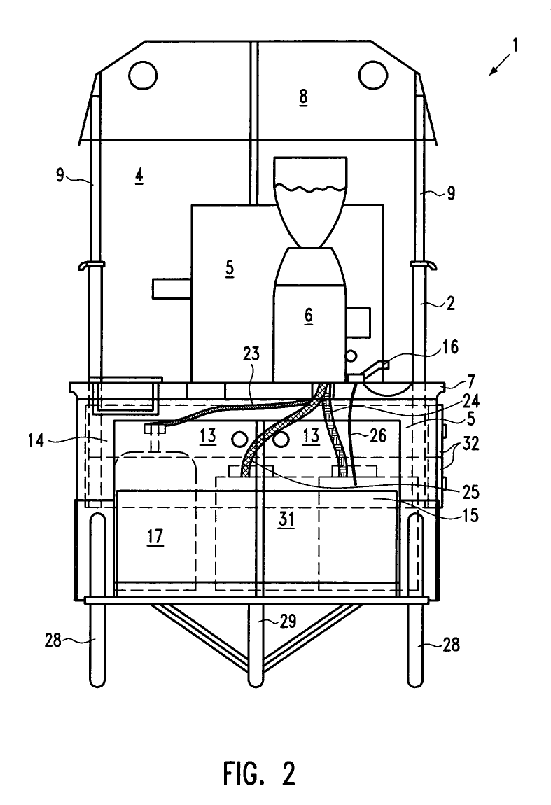

FIG. 2 shows the embodiment of the mobile serving unit 1 of FIG. 1 in a front view sectioned directly behind the front wall off the lower level 11. The same elements as in FIG. 1 are provided with the same reference numbers.

Now visible is the waste water container 31, which has a fluid connection with the coffee making machine via the first waste water pipe 25, to carry waste water away from the coffee making machine. Also discernible now are the two flaps 13 in the front wall of the lower level 11, together with flaps 32 in the side wall of the lower level 11.

The width of the lower level 11 including side walls is 980 mm.

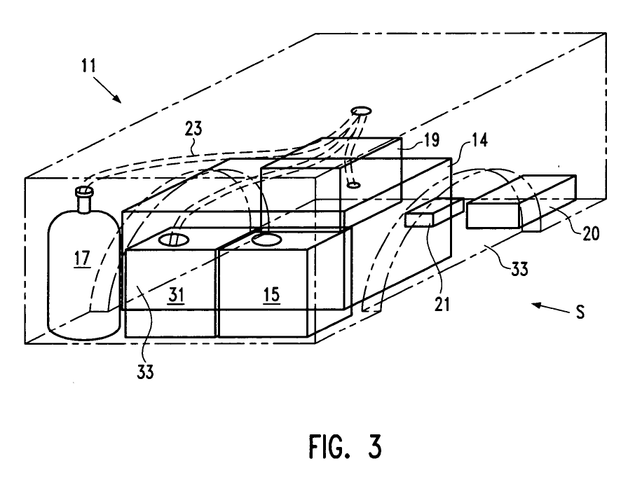

FIG. 3 now shows, further simplified, the mobile serving unit 1 of the serving platform 2 of the mobile serving unit 1 of FIGS. 1 and 2 in an oblique view, once again making clear the layout of the objects contained therein. In a side view S on the left-hand side and looking from front to rear, there are the second fresh water tank 15, the waste water container 31 and the gas cylinder 17. In the middle, between wheel housings 33 is the first fresh water tank 14. Alongside on the right are firstly the inverter 20 and the battery charger 21, and behind them the battery 19.

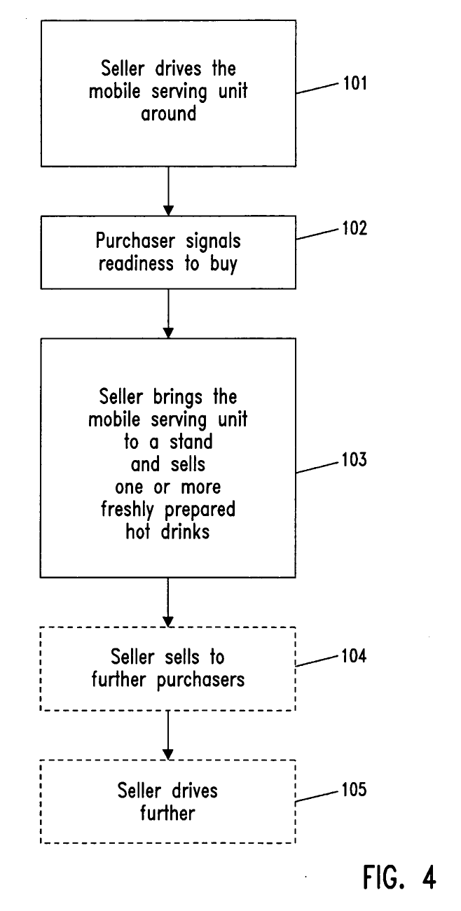

FIG. 4 shows a flow chart of a method of operating the mobile serving unit. To begin with, in a first step 101, the mobile serving unit is moved by a seller, e.g. by the latter pedaling around in a recreational facility (park, etc.). In the next step 102, a potential purchaser signals his readiness to buy through one or more hand signals to the seller. Thereupon, in the next step 103, the seller brings the mobile serving unit to a stand, optionally moving closer to the purchaser beforehand, and sells the purchaser one or more hot drinks which have been made by an appliance, at least partly gas-powered, of the mobile serving unit, preferably coffee in one of its many variants (e.g. black, espresso, latte macchiato, cappuccino, etc.), but also tea, hot chocolate and the like. Preferably, in an optional step 104, the seller sells hot drinks and/or hot food (toasts, pannini, etc.) to several purchasers at the same spot. In an optional step 105, the seller then continues his journey.

For the sale of coffee, the seller operates a coffee making machine, at least partly gas-powered, in the mobile serving unit. For this purpose a release mechanism, e.g. a control knob, may be operated, which is connected to an electrical control unit powered by the battery The control circuit initiates a brewing process or generates steam (e.g. for foamed milk or tea), in which hot water is produced through burning of the gas. Other mechanical operations may in turn be provided by electric motors, e.g. grinding of coffee or ejection of coffee grounds. Since the production of hot water is by far the most energy-intensive process, it is possible to operate the coffee making machine for quite a long time with the assistance of just a relatively small battery. In this invention, the design and control of known coffee making machines are hereby included in full by reference.

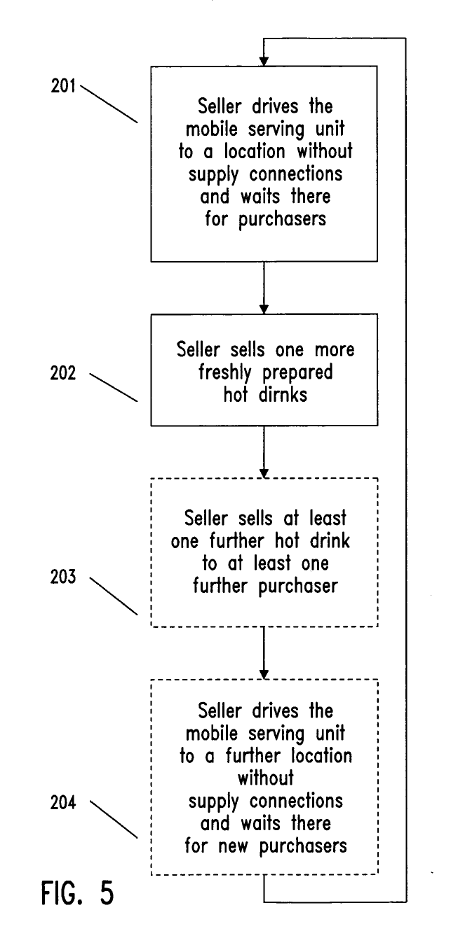

FIG. 5 shows a flow chart of a further method of operating the mobile serving unit. To begin with, in a first step 201, the mobile serving unit is driven by a seller to a location which does not have a supply connection usable by the seller, e.g. in a green space, and is there set up ready for selling. In a second step 202, a potential purchaser gives one or more signals to buy to the seller, who sells the purchaser in a final step 203 a hot drink, freshly prepared using an appliance, at least partly gas-powered, of the mobile serving unit.

Preferably, in an optional step 204, further freshly heated-up or prepared fare, in particular hot drinks such as coffee, is sold to further purchasers.

Similarly, the seller preferably moves the mobile serving unit in a subsequent step 205 to another location which does not have a supply connection usable by the seller.

The invention also covers a combination of both methods of selling. Naturally the invention is not limited to the selling or operating methods described but also covers any kind of sales initiation or implementation, including sales negotiation and transaction of business. The known methods of sales initiation, sales negotiation and transaction of business are hereby part of the invention to their full extent.

Key to FIGS. 1-3: 1 mobile serving unit; 2 serving platform; 3 transport unit; 4 upper level; 5 coffee making machine; 6 coffee grinder; 7 intermediate surface; 8 roof; 9 bar; 10 rear-view mirror; 11 lower level; 12 base plate; 13 flap; 14 first fresh water tank; 15 second fresh water tank; 16 water tap; 17 gas cylinder; 18 valve; 19 battery; 20 inverter; 21 battery charger; 22 drawers; 23 gas pipe; 24 first fresh water pipe; 25 first waste water pipe; 26 second fresh water pipe; 27 second waste water pipe; 28 front wheels; 29 rear wheel; 30 pedals; 31 waste water container; 32 flaps; and 33 wheel housing.

While this invention has been particularly shown and described with references to preferred embodiments thereof, it will be understood by those skilled in the art that various changes in form and details may be made therein without departing from the scope of the invention encompassed by the appended claims.

What is claimed is:

1. Mobile serving unit comprising at least:
a serving platform;
a transport unit which may be pedal-operated, for moving the serving platform, and
an appliance, at least partly powered by gas, for the preparation of food and/or drink.

2. Mobile serving unit according to claim 1, wherein
the transport unit is a cycle with two front wheels, and
the serving platform rests at least partly on associated front wheels of the cycle.

3. Mobile serving unit according to claim 1, wherein the appliance or appliances operable at least partly with gas is or are a coffee making machine.

4. Mobile serving unit according to claim 3, in which a gas container, a first fresh water tank and a waste water container are also provided, and may be connected to the coffee making machine.

5. Mobile serving unit according to claim 4, in which there is also provided an energy storage unit, which may be connected to the coffee making machine.

6. Mobile serving unit according to claim 5, in which there is also provided a grinder, which may be connected to the energy storage unit.

7. Mobile serving unit according to claim 1, in which the serving platform has several levels.

8. Mobile serving unit according to claim 6, in which at least one gas container and/or a fresh water tank and/or a waste water container and/or an energy storage unit are located on a lower level.

9. Mobile serving unit according to claims 8, in which a coffee making machine which is at least partly gas-powered, and/or a grinder, are located on an upper level.

10. Mobile serving unit according to claim 1, in which there is provided at least one water tap which may be supplied with fresh water by a second fresh water tank.

11. Method of operating the mobile serving unit including a serving platform; a transport unit which may be pedal-operated, for moving the serving platform, and an appliance, at least partly powered by gas, for the preparation of food and/or drink, the method for the serving of hot drinks, in particular coffee, comprising at least the steps:
movement of the mobile serving unit by a seller;
the giving to the seller, by one or more potential purchasers, of a signal to purchase;
stopping of the mobile serving unit by the seller, and the selling of one or more freshly prepared hot drinks by the seller to the purchaser, from the mobile serving unit.

12. Method according to claim 11, wherein there is a subsequent step of selling hot drinks to several purchasers.

13. Method according to claim 12, in which there is a subsequent step of further movement of the mobile serving unit by the seller.

14. Method of operating the mobile serving unit including a serving platform; a transport unit which may be pedal-operated, for moving the serving platform, and an appliance, at least partly powered by gas, for the preparation of food and/or drink, the method for serving of hot drinks, in particular coffee, comprising at least the steps:
movement of the mobile serving unit by a seller to a location which does not have a supply connection usable by the seller; and
selling of one or more hot drinks by the seller to the purchaser from the mobile serving unit.

15. Method according to claim 14, wherein there is a subsequent step of selling hot drinks to at least one further purchaser.

16. Method according to claim 15, in which there is a subsequent step of further movement of the mobile serving unit by the seller to a location which does not have a supply connection usable by the seller.
